(19) United States
(12) Patent Application Publication
(10) Pub. No.: US 2005/0056702 A1
(43) Pub. Date: Mar. 17, 2005

(54) Non-reproducible document and method for preventing the reproduction of documents

(76) Inventor: Jean J. Robillard, Leon (MX)

Correspondence Address: ROSENBERG, KLEIN & LEE, 3458 ELLICOTT CENTER DRIVE-SUITE 101, ELLICOTT CITY, MD, 21043, US

(21) Appl. No.: 10/659,350

(22) Filed: Sep. 11, 2003

(51) Int. Cl. G06K 19/06

(52) U.S. Cl. 235/490

(57) ABSTRACT

A system and method for preventing the reproduction of documents is provided. A non-reproducible document (10) is formed from a base layer (12) having a holographic layer (14) formed on an upper surface (13) thereof. Holographic layer (14) covers indicia (16) printed on upper surface (13). The holographic layer (14) deflects light generated by a reproduction process so that indicia (16) cannot be reproduced.

### BACKGROUND OF THE INVENTION

1. Field of the Invention

The subject invention relates to a non-reproducible document and a method for preventing the reproduction of documents. In particular, the present invention directs itself to a document formed from a base layer having indicia printed thereon with a holographic layer being formed on the base layer and covering the indicia. More particularly, the holographic layer is designed to reflect and scatter light from a photocopier or other reproduction process in order to prevent reproduction of the indicia.

Further, the holographic material used may be included as part of the base stock which forms the base layer. Thus, the base layer itself would form a holographic layer for preventing reproduction. Additionally, the holographic material may form an organic pigment for the formation of the indicia.

2. Prior Art

Methods and systems for the prevention of reproduction of a document are well-known in the art. In general, such prior art systems and methods utilize a watermark or some other form of hidden or invisible indicia or markings. Such systems and methods, however, allow for the reproduction and visibility of the indicia printed on the document and only add additional security markings for covering or marking part of the document. It is a purpose of the subject invention to provide a system and method for prevention of the reproduction of documents utilizing a holographic layer which reflects and scatters the light of a reproduction process, thus preventing the reproduction and visibility of any indicia or markings printed on the document.

### SUMMARY OF THE INVENTION

The present invention provides for a system and method for the prevention of the reproduction of documents. A document is established having indicia printed thereon and a holographic layer is formed on the surface of the document. The holographic layer is designed to scatter or reflect the light generated by a photocopying machine or other reproduction process. The holographic layer may be formed as a layer positioned above the indicia printed on the document, or may be formed as part of the base surface, or as an organic pigment used to print the indicia.

It is a principle objective of the subject system and method for the prevention of reproduction of documents to provide a document having a holographic layer formed thereon.

It is a further objective of the subject system and method for the prevention of the reproduction of documents to provide a holographic layer which deflects light generated by a reproduction process in selective directions.

It is a further objective of the subject invention to provide a document having a holographic layer formed over separate and independent regions of the document.

It is a further objective of the subject invention concept to provide a non-reproducible document having a holographic material forming the base layer of the document.

It is a further objective of the subject system and method for the prevention of the reproduction of documents to provide a holographic material forming an organic pigment for the formation of indicia on the document.

It is an important objective of the present invention to provide a holographic layer for documents to reflect and scatter light generated by a photocopying machine in order to prevent reproduction of the indicia formed on the document.

### BRIEF DESCRIPTION OF THE DRAWINGS

FIG. 1 is a side view of the subject non-reproducible document;

FIG. 2 is a top view of the non-reproducible document with a cut-away view of the holographic layer;

FIG. 3 is a schematic diagram of an attempted reproduction process on the unreproducible document;

FIG. 4 is a top view of an alternative embodiment of the unreproducible document having separate regions of the document covered with the holographic layer;

FIG. 5 is a schematic diagram of an attempted reproduction process of the document of the embodiment of FIG. 4;

FIG. 6 is a magnified view of the base layer of the document of an alternative embodiment where the holographic material is used to form the base layer; and,

FIG. 7 is a magnified view of the indicia printed on the document of an alternative embodiment of the non-reproducible document where the holographic material is used to form an organic pigment for printing the indicia.

### DESCRIPTION OF THE PREFERRED EMBODIMENTS

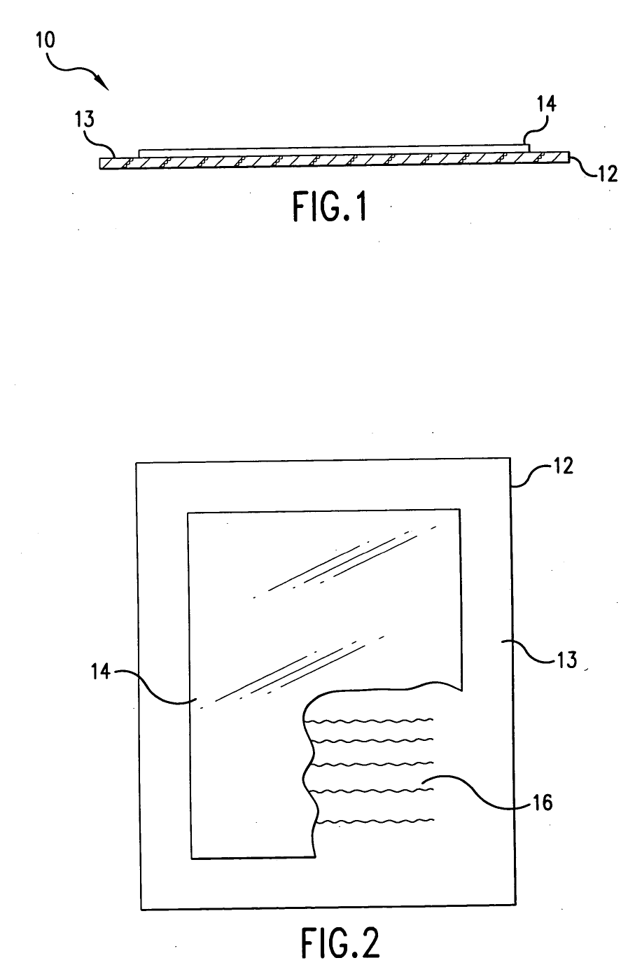

Referring now to FIGS. 1-3, there is shown a non-reproducible document 10. The non-reproducible document 10 includes a base layer 12 and a holographic layer 14. The base layer 12 is formed from paper, plastic, or any other standard material used for forming documents.

As shown in FIG. 2 of the Drawings, an upper surface 13 of base layer 12 has indicia 16 printed thereon. Indicia 16 may be printed on upper surface 13 of base layer 12 by any standard printing means.

As shown in FIGS. 1 and 2, a holographic layer 14 is formed on upper surface 13 of base layer 12 and overlapping indicia 16. The holographic layer 14 may be a Fresnel zone plate hologram, a Bragg plane diffraction hologram, or any other suitable type of reflection hologram layer. The holographic layer 14 is formed on base layer 12 in order to deflect light generated by a reproduction process in order to prevent reproduction of indicia 16.

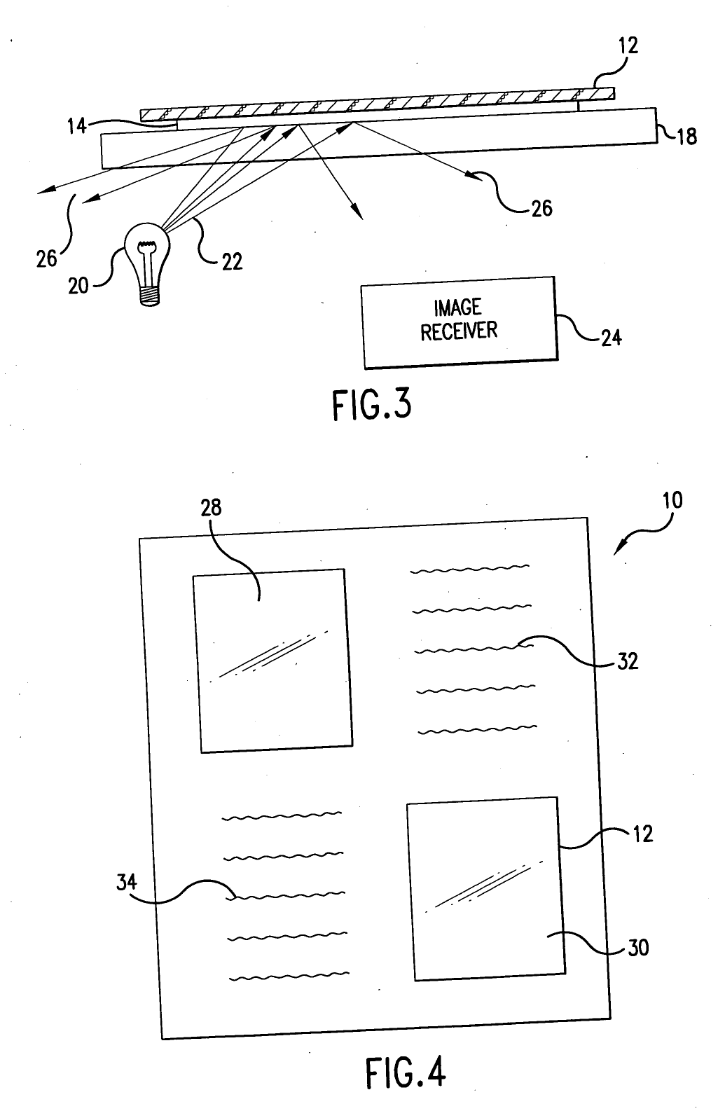

FIG. 3 illustrates an attempted reproduction of the non-reproducible document 10. As shown in the Figure, the non-reproducible document 10 is positioned on a glass plate 18, such as the face plate in a standard photocopying machine. The holographic layer 14 is pressed against the upper surface of glass plate 18 and a light source 20 is positioned beneath the plate 18. Ordinarily, light 22 is generated by light source 20, passes through glass plate 18 and is reflected from the surface of the conventional document to be copied, with the reflected light being picked up by image receiver 24.

As shown in FIG. 3, the holographic layer 14 produces scattered light rays 26 which are not picked up by image receiver 24. Thus, document 10 is rendered unreproducible through standard optical processes. Although shown in FIG. 3 as a scattering process, the holographic layer 14 may be formed to directionally reflect the light generated by light source 20. In other words, the light generated by light source 20 could be reflected or deflected in a user-selectable direction. This would allow the user to either reflect light completely away from the image pick-up 24, or direct all of the light into the image pick-up 24, thus obscuring the reflected image and deterring reproduction of the document. The degree of scattering or the specific angles of reflection of the light generated by light source 20 may be selectively chosen by a user. During the production process, the holographic layer 14 may be formed by altering grating sizes, thickness and the like in order to allow a user to vary the parameters in order to selectively choose the angular extent and direction of the reflection or scattering.

Holograms are ideal for refracting and scattering light during the photocopying process. A hologram preserves the phase relationship between the light from an object and that from a reference source on a recording medium, such as a film plate. After processing the hologram, if it is placed in the same position in the reference beam, one observes (for most objects) two images: a real image and a virtual image.

If on the hologram plane φ(x) is the phase of the object beam, and φ_{R} (x) is the phase of the reference beam, the resultant holographic transmittance, in terms of the amplitude ratio of the reference and object beams, is given by:

$$τ ( x ) = {τ}_{0} \{ 1 - \frac{γ A ( x )}{{A}_{R}} cos [ ϕ ( x ) - {ϕ}_{R} ( x ) ] \} \qquad ( 1 )$$

, where τ₀ is the average transmittance, A(x) and A_{R} are the amplitudes of the object and reference beam's electric fields, and γ is the film response. After processing, the hologram is placed in a reference beam with an electric field Eᵢ. There are three components of the reconstructed beam's electric field Eₜ:

$${E}_{t} = τ {E}_{r} - \frac{γ {τ}_{0}}{2} A ( x ) cos [ ω t + ϕ ( x ) ] - \frac{γ {τ}_{0}}{2} A ( x ) cos [ ω t - ϕ ( x ) + 2 {ϕ}_{R} ( x ) ] \qquad ( 2 )$$

The first term of the reconstructed beam's electric field is the propagation of the beam illuminating the hologram. The second term is the reconstruction of the object beam. This reconstruction produces a virtual image at the original position of the object. The last term produces an angularly displaced real image.

In order to utilize holography to disrupt photocopying, the hologram can be used to prevent light from entering the focusing system of the photocopying machine. One such type of holographic layer adapted for this use is a grating-type hologram. Alternatively, the hologram can be constructed to enhance reflected light on the imaging optics of the copying machine. This would cause bright spots in the image plane, thus destroying the images. Using the light scattering technique to reduce the reflected light to the photocopier imaging optics, however, results in some light still being available for image pick-up. The available light is given by the first term in equation (2) for the reconstructed beam's electric field. Therefore, an extremely efficient hologram must be utilized wherein the elements associated with the first term in equation (2) are minimized. Examples of suitable holograms include Fresnel zone plate-type holograms and Bragg plane diffraction-type holograms. Both Fresnel and Bragg type holograms are well-known in the art. Such holograms are taught in E. Hecht, Optics, Second Edition (1990), pp. 595, 606-607.

The directional reflection technique offers fewer limitations, as large perturbations in light intensity can be produced. Light from the hologram's reconstructed virtual image beam can be directed toward the copier's imaging optics in order to cause saturation of the photosensitive surface.

Good quality phase holograms of several point sources, which satisfy the different possible geometries of a photocopier, offer efficient photocopy deterrents. Many photocopying machines either use off-axis angle illuminators or off-axis focusing optics, or variations of these configurations. For these reasons, holograms of off-axis point sources provide a method of modifying the image intensity of the photocopying machines. On the hologram plane, the phase of a near off-axis point source, either from the reference or object beams, is given by:

$$\begin{matrix}ϕ - ϕ ( x ) - ϕ ( 0 ) \approx - \frac{2 π}{λ} \frac{( {x}^{2} + {y}^{2} - 2 x {x}_{s} - 2 y {y}_{s} )}{2 D} & ( 3 ) \\ ϕ \approx - \frac{2 π}{λ} [ \frac{{x}^{2} + {y}^{2}}{2 D} + ( α x + β y ) ] & ( 4 )\end{matrix}$$

, where x and y are the respective distances from the hologram's center, xₛ and yₛ are offset distances of the source, D is the perpendicular distance from the holographic plane to the source, and

$$α = \frac{{x}_{s}}{D} , β = \frac{{y}_{s}}{D} \qquad ( 5 )$$

The transmittance of the hologram produced by a point reference source and a point object source having different phases due to their different distances and offsets, is of the form, where A(x) is the object field amplitude:

$$τ = {τ}_{0} [ 1 - γ \frac{A ( x )}{{A}_{R}} cos ( ϕ - {ϕ}_{R} ) ] \qquad ( 6 )$$

For photocopiers, one can consider that the reconstruction source is a point source at a different distance D_{C}, with offsets x_{c} and y_{c}. Generally, the photocopier light source can be considered a sequence of such point sources. The photocopier source is also a broadband wavelength source. The locations of the reconstructed images for the different positions and wavelength composition of the photocopier source can be determined. The transmitted light will be given by

$${E}_{t} = {τ}_{0} {E}_{C} - γ \frac{{τ}_{0}}{2} \frac{A ( x ) {A}_{C}}{{A}_{R}} cos ( ω t + ϕ - {ϕ}_{R} + {ϕ}_{C} ) - \\ γ \frac{{τ}_{0}}{2} \frac{A ( x ) {A}_{C}}{{A}_{R}} cos ( ω t + {ϕ}_{C} - ϕ + {ϕ}_{R} ) \qquad ( 7 )$$

, where φ, φ_{R} and φ_{C} are the phases for the object, reference and photocopier beams, respectively, and the photocopier electric field is given by
   E_{C}=A_{C} cos(ω′t+φ₀) (8)

The phase is given by the second term of equation (7) and the virtual image is given by

$$( ϕ ( x ) - {ϕ}_{R} + {ϕ}_{C} ) - ( ϕ ( O ) - {ϕ}_{R} ( O ) + {ϕ}_{C} ( O ) ) ≅ \\ \frac{2 π}{{λ}^{′}} \{ x [ ( α - {α}_{R} ) ( \frac{{λ}^{′}}{λ} ) + {α}_{C} ] + \frac{{x}^{2}}{2} [ ( \frac{1}{D} - \frac{1}{{D}_{R}} ) \frac{{λ}^{′}}{λ} + \frac{1}{{D}_{C}} ] \} ≅ - \\ \frac{2 π}{{λ}^{′}} [ x {α}^{′} + \frac{{x}^{2}}{2 {D}^{′}} ] \qquad ( 9 )$$

, where λ′ is the wavelength of the photocopier source. The reconstructed virtual image is located at a distance D′ with a directional cosine of α, where D′ is given by:

$$\frac{1}{{D}^{′}} = ( \frac{1}{D} - \frac{1}{{D}_{R}} ) \frac{{λ}^{′}}{λ} + \frac{1}{{D}_{C}} \qquad ( 10 )$$

and α′ is given by:

$${α}^{′} = ( α - {α}_{R} ) \frac{{λ}^{′}}{λ} + {α}_{C} . \qquad ( 11 )$$

Similarly, the phase of the third term, which represents the real image, is given by:

$$\begin{matrix}[ - ϕ ( x ) + {ϕ}_{R} + {ϕ}_{C} ] - [ - ϕ ( 0 ) + {ϕ}_{R} ( 0 ) + {ϕ}_{C} ( 0 ) ] ≅ - \frac{2 π}{{λ}^{′}} [ x {α}^{″} + \frac{{x}^{2}}{2 {D}^{″}} ] \\ where , & ( 12 ) \\ \frac{1}{{D}^{″}} = ( \frac{1}{{D}_{R}} - \frac{1}{D} ) \frac{{λ}^{′}}{λ} + \frac{1}{{D}_{C}} \\ and , & ( 13 ) \\ {α}^{″} = ( {α}_{R} - α ) \frac{{λ}^{′}}{λ} + {α}_{C} & ( 14 )\end{matrix}$$

Holograms of point sources are generally Fresnel diffraction patterns. Essentially, the theory of Fresnel diffraction may be used with reference to holography. The Fresnel theory implies that suitable locations for the point sources can be computed with reasonable accuracy, even though the hologram may be produced using a HeNe laser. Although the Fresnel theory is generally applied to holography, two types of reflection holograms can be used to prevent photocopying: Fresnel zone plate-type holograms and Bragg plane diffraction-type holograms.

Fresnel zone plate reflection holograms are designed to reflect light into a small point within the input optics of the photocopier. Because the hologram is characterized by non-constant line spacing, some blurring is caused by the high intensity points not being in the object plane of the optical system, and by light differing from the design wavelength. Wavelengths near the design wavelengths are reflected at slightly different angles.

Bragg plane diffraction type holograms are made using parallel beams and are highly directional. These holograms are very efficient at their designed wavelength, but are highly wavelength dependent and small holograms (on the order of 1 cm in diameter) reflect enough light to cause saturation. The adverse effect of the high angular dependence of the simple two-beam Bragg plane hologram can be corrected using holograms made with multiple beams. One such holographic design would require one beam, representing the optical system input, be held at normal incidence, with the others, all at 45° with respect to normal incidence, being at various azimuths. Thus, the hologram would be rotated without substantial degradation of the reflected beam.

Holographic layer 14 may be formed on upper surface 13 of base layer 12 from holographic materials which deflect incoming light in selective directions. The entire upper surface 13 of base layer 12 could be covered with a hologram layer 14 which scatters the incoming light 22 in a selected direction.

Alternatively, separate regions of the base layer 12 could be selectively covered with separate holographic layers, as shown in FIG. 4 of the Drawings. In FIG. 4, the non-reproducible document 10 includes base layer 12 having separate holographic layers 28 and 30 positioned on different regions of the upper surface 13. Regions 32 and 34 of the base layer 12 remain uncovered and are, thusly, reproducible. Each separate holographic layer 28, 30 could be selected to have a specific angular reflectance; i.e., light in that region would be reflected along a user-selectable angle. Additionally, each separate holographic layer 28, 30 could be designed for reflection or scattering of light of a specific range of wavelengths.

As shown in FIG. 5 of the Drawings, an attempt to reproduce the document yields scattered light rays 40 and 42. In this example, the document 10 is positioned on a similar reproducing apparatus to that shown in FIG. 3. In this example, holographic layers 28 and 30, of FIG. 4, are pressed against the upper surface of glass plate 18. Incident light 36 generated by light source 20 impinges upon first holographic layer 28. The light 36 is then scattered into scattered light rays 40, with the direction of scattering being user-selectable. The degree of scattering, or the direction of reflectance of the light rays, may be chosen and controlled by the user during the manufacturing process. The holographic layers may be produced according to user-selectable factors such as angular and frequency dependent scattering and reflection. Similarly, incident light rays 38 impinge upon holographic layer 30. The direction of scattering of scattered light rays 42 are also user-selectable depending upon the angular parameters chosen during the production process.

In order to create non-reproducible documents, the holographic layers 14 are formed from high efficiency phase holographic materials, such as variable refractive index materials. The variable refractive index material may be a photopolymer, a photocrosslinkable polymer, an organic semiconductor, or any other suitable high efficiency material.

In forming the holographic layer 14 on the upper surface 13 of base layer 12, the variable refractive index material may be coated onto surface 13 as a thin film layer. A suitable thickness for such a thin film layer is approximately 10 micrometers.

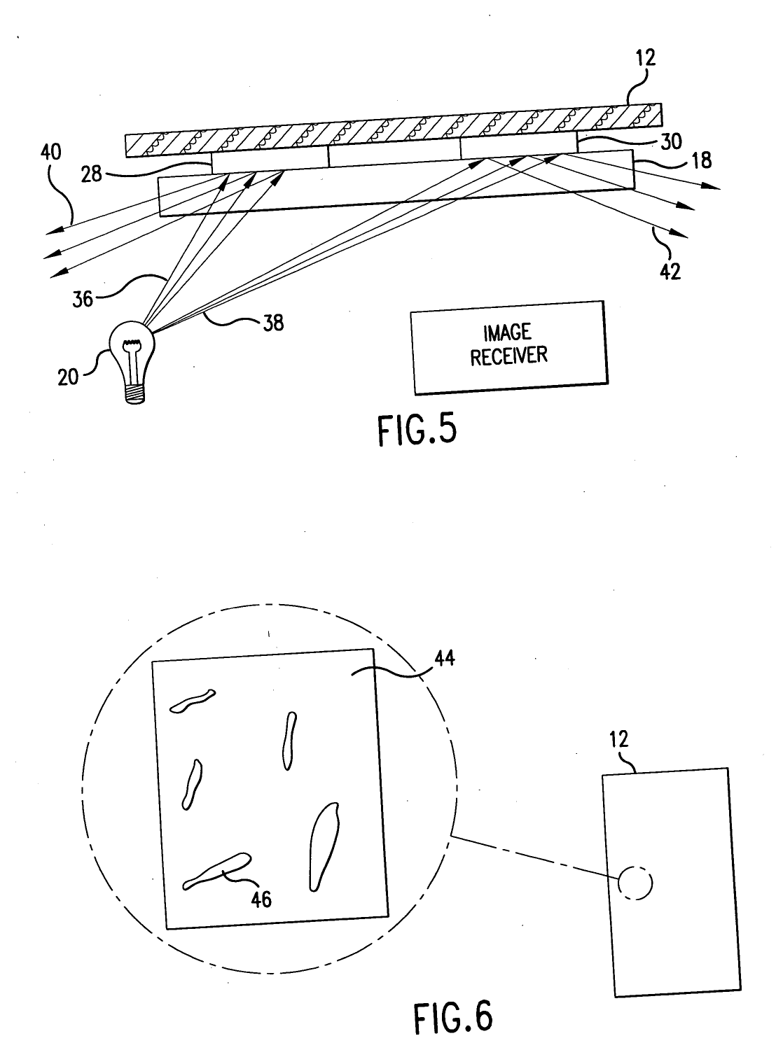

Alternatively, the non-reproducible document 10 may be produced by forming base layer 12 from some standard base stock having the variable refractive index material contained therein as an organic pigment. As shown in FIG. 6, base stock 44 includes regions of variable refractive index material 46 as an organic pigment. In this embodiment, the hologram would then be able to be recorded directly on the variable refractive index material formed within base layer 12. A suitable concentration of the organic pigment in the base stock material for forming the base layer 12 would be approximately 1 to 5.

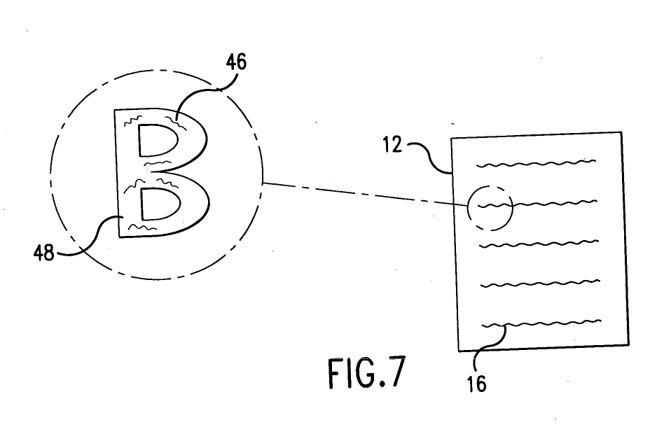

In a further alternative embodiment shown in FIG. 7, the variable refractive index material could be contained within a printing ink, formed as an organic pigment, for printing indicia 16 on base layer 12. In this embodiment, the hologram 14 could be recorded directly onto the printing ink of indicia 16. A suitable concentration of the organic pigment within the printing ink would be approximately 1 to 5 by volume.

In a further alternate embodiment, base layer 12 and indicia 16 may be formed from a variety of colored materials and pigments. Holographic layer 14 formed on upper surface 13 of base layer 12 could be a multi-image type hologram where each image corresponds to a selected wavelength range of light reflected from indicia 16 and from upper surface 13 of base layer 12.

Although this invention has been described in connection with specific forms and embodiments thereof, it will be appreciated that various modifications other than those discussed above may be resorted to without departing from the spirit or scope of the invention. For example, functionally equivalent elements may be substituted for those specifically shown and described, proportional quantities of the elements shown and described may be varied, and in the formation method steps described, particular steps may be reversed or interposed, all without departing from the spirit or scope of the invention as defined in the appended claims.

1. A method for preventing the reproduction of documents comprising the steps of:
(a) establishing a document having indicia printed thereon; and,
(b) forming a hologram on a surface of said document, said hologram being positioned for preventing reproduction of at least a portion of said indicia by reflecting light generated by a document reproduction device in a predetermined manner.

2. The method for preventing the reproduction of documents as recited in claim 1 wherein said hologram of said formation step is formed to deflect light in selective directions.

3. The method for preventing the reproduction of documents as recited in claim 1 wherein said formation step includes selectively forming said hologram over a plurality of separate regions of said document.

4. The method for preventing the reproduction of documents as recited in claim 1 wherein said hologram is formed as a high efficiency phase hologram.

5. The method for preventing the reproduction of documents as recited in claim 1 wherein said formation step includes recording said hologram on a variable refractive index material.

6. The method for preventing the reproduction of documents as recited in claim 5 wherein said variable refractive index material is a photopolymer.

7. The method for preventing the reproduction of documents as recited in claim 5 wherein said variable refractive index material is a photocrosslinkable polymer.

8. The method for preventing the reproduction of documents as recited in claim 5 wherein said variable refractive index material is an organic semiconductor.

9. The method for preventing the reproduction of documents as recited in claim 5 wherein said step of forming a hologram includes coating said document with a thin film layer of said variable refractive index material.

10. The method for preventing the reproduction of documents as recited in claim 9 wherein said thin film layer is formed with a thickness of 10 micrometers.

11. The method for preventing the reproduction of documents as recited in claim 5 wherein said step of establishing said document includes forming said document from a base stock having said variable refractive index material contained therein as an organic pigment.

12. The method for preventing the reproduction of documents as recited in claim 11 wherein said organic pigment has a concentration of 1 to 5 by volume in said base stock.

13. The method for preventing the reproduction of documents as recited in claim 5 wherein said step of establishing said document includes formation of said indicia from a printing ink containing said variable refractive index material therein as an organic pigment.

14. The method for preventing the reproduction of documents as recited in claim 13 wherein said organic pigment has a concentration of 1 to 5 by volume in said printing ink.

15. A non-reproducible document comprising:
a base layer having an upper surface, said upper surface having indicia printed thereon;
a hologram formed on said upper surface of said base layer, wherein said hologram deflects light generated by a reproduction process to prevent reproduction of said indicia.

16. The non-reproducible document as recited in claim 15 wherein said hologram deflects said light in selective directions corresponding to specific regions of said base layer.

17. The non-reproducible document as recited in claim 15 wherein said hologram produces a plurality of images, each said image corresponding to a selected wavelength range of light reflected from said indicia.

18. The non-reproducible document as recited in claim 15 wherein said hologram is a high efficiency phase hologram.

19. The non-reproducible document as recited in claim 15 wherein said hologram is recorded on a variable refractive index material.

20. The non-reproducible document as recited in claim 19 wherein said variable refractive index material is a photopolymer.

21. The non-reproducible document as recited in claim 19 wherein said variable refractive index material is a photocrosslinkable polymer.

22. The non-reproducible document as recited in claim 19 wherein said variable refractive index material is an organic semiconductor.

23. The non-reproducible document as recited in claim 19 wherein said variable refractive index material is formed on said upper surface of said base layer as a thin film layer.

24. The non-reproducible document as recited in claim 23 wherein said thin film layer has a thickness of 10 micrometers.

25. The non-reproducible document as recited in claim 19 wherein said base layer is formed from a base stock having said variable refractive index material contained therein as an organic pigment.

26. The non-reproducible document as recited in claim 25 wherein said organic pigment has a concentration of 1 to 5 by volume in said base stock.

27. The non-reproducible document as recited in claim 19 wherein said indicia is formed from a printing ink having said variable refractive index material contained therein as an organic pigment.

28. The non-reproducible document as recited in claim 27 wherein said organic pigment has a concentration of 1 to 5 by volume in said printing ink.
